(19) United States
(12) Patent Application Publication
(10) Pub. No.: US 2025/0033653 A1
(43) Pub. Date: Jan. 30, 2025

(54) DYNAMIC CONTROL OF REMOTE ASSISTANCE SYSTEM DEPENDING ON CONNECTION PARAMETERS

(71) Applicant: GM Cruise Holdings LLC, San Francisco, CA (US)

(72) Inventor: Katherine Mary Stumpf, San Francisco, CA (US)

(21) Appl. No.: 18/359,598

(22) Filed: Jul. 26, 2023

(51) Int. Cl. B60W 50/029; B60W 60/00

(52) U.S. Cl. CPC B60W 50/029; B60W 60/0015; B60W 2556/45

(57) ABSTRACT

Systems and techniques are provided for dynamically controlling remote assistance system for an autonomous vehicle (AV) based on delayed or missing data. An example process includes determining a delay in receiving data from an AV at a first period of time and identifying a task for the remote assistance system at the first period of time. The task can include one or more actions corresponding to one or more input elements on a remote assistance interface. The example process further includes determining a dependence of the task on the data at the first period of time based on one or more parameters, and based on the dependence of the task on the data, adjusting at least one of the one or more input elements of the remote assistance interface and the one or more actions associated with the one or more input elements.

### BACKGROUND

### 1. Technical Field

The present disclosure generally relates to a remote assistance system. For example, aspects of the present disclosure relate to techniques and systems for dynamically controlling a remote assistance system for an autonomous vehicle based on delayed or missing data.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 illustrates a diagram illustrating an example system environment in which an AV is in communication with a remote assistance system, according to some examples of the present disclosure;

FIG. 3 is a flow diagram illustrating an example process for dynamically adjusting a remote assistance system based on delayed or missing information, according to some examples of the present disclosure;

FIG. 4 illustrates a diagram illustrating an example user interface of a remote assistance system, according to some examples of the present disclosure;

FIG. 5 is a flowchart illustrating an example process for dynamically controlling a remote assistance system of an AV based on latency, according to some examples of the present disclosure; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously described, an autonomous vehicle (AV) is a motorized vehicle that does not require a human driver. An AV is equipped with various sensors to perceive and navigate the surrounding environment. In some instances, an AV system may encounter an object or scenario (e.g., unfamiliar or challenging objects or ambiguous scenarios) that may inhibit the operation of the AV and therefore additional guidance is desired during the decision-making process. A remote operator (e.g., a human operator, a remote assistant, or a remote advisor) may be connected to an AV through a remote assistance system that facilitates communication between the remote operator and the AV for remote assistance or control. For example, a remote assistance system allows the remote operator to receive sensor data from the AV (e.g., live video feeds, sensor readings and measurements, diagnostic information, etc.) so that the remote operator can provide guidance, instructions, or interventions to the AV.

A remote assistance system needs up-to-date comprehensive information to maintain situational awareness of the scene so that it can make accurate decisions and provide real-time support for an AV. When there is latency/delay or absence of information/data in a remote assistance system, the information received by the remote operator may be outdated, which can result in a response of the remote operator also being outdated. For example, when there is a time delay between sensor data sent by an AV and receipt of that sensor data by a remote assistance system, or between an instruction sent by a remote assistance system and receipt of that instruction by an AV, the delay can result in assistance and/or operation problems as the AV may not receive timely guidance or instructions to handle challenging situations.

Systems, apparatuses, processes (also referred to as methods), and computer-readable media (collectively referred to as “systems and techniques” or “system”) are described herein for dynamically controlling a remote assistance system associated with an AV based on delayed or missing information (e.g., latency, delayed sensor data, absence of sensor data, etc.). In some aspects, the systems and techniques described herein can dynamically adjust one or more actions for remote assistance based on latency (e.g., a time delay in communication between a remote assistance system and an AV) or absence of data. For example, one or more actions for remote assistance enabled by a remote assistance system can be dynamically disabled or restricted to prevent or restrict a remote operator from implementing/activating the one or more actions via the remote assistance system. In some examples, the one or more actions can be disabled or restricted based on latency of data/communications between the AV and the remote computing system.

In some aspects, the systems and techniques can adjust one or more actions per task assigned for a remote assistance request, based on one or more parameters when there is latency in communication between a remote assistance system and an AV (e.g., missing or delayed sensor data). For example, upon determining a delay in receiving sensor data from an AV, a remote assistance system may identify a task that is associated with the remote assistance request. Depending on a task, a remote assistance system may need different types of information to determine one or more actions (or a series of actions in a certain order) that can or should be carried out to resolve the challenge encountered by the AV. As follows, the systems and techniques can determine whether the missing or delayed sensor data is needed for determining one or more actions/suggestions/proposals for the remote assistance request.

In some approaches, the systems and techniques can determine a dependence (or a level of dependence) of the task on the missing or delayed sensor data based on one or more parameters such as a safety parameter, a performance parameter, an environmental parameter, a timeliness parameter, and so on. As follows, by leveraging a variety of information associated with the scene and the AV, the systems and techniques can determine dependence of the task on the missing or delayed sensor data and adjust one or more actions for input from a remote operator accordingly. For example, if the safety of the AV would be undermined or compromised if remote assistance is provided to the AV without the missing or delayed sensor data, the systems and techniques can disable at least one action of the one or more actions/suggestions/proposals that might impact the safety of the AV and/or its surroundings.

In some examples, the systems and techniques can display the adjusted one or more actions for input from a remote operator on an interface at a device associated with the remote operator. For example, on a graphical user interface (GUI) at a remote operator's device, one or more actions can be disabled, hidden, deactivated, or made un-selectable for remote operator's input so that a remote assistance UI (e.g., GUI at a remote operator's device) can present dynamically adjusted actions that may be available when there is missing or delayed sensor data.

In some cases, the systems and techniques can reject input or commands to carry on certain actions that are or should have been disabled, hidden, deactivated, or made un-selectable on a GUI. For example, the systems and techniques described herein can have an AV reject the one or more actions that may require the missing or delayed data to be present to determine whether such actions can be carried out to resolve the remote assistance request. As follows, an AV may discard a remote operator's input that was provided without necessary data/information.

Aspects of the disclosed technology can improve the safety and performance of an AV by accounting for latency in transmitting and/or receiving data (e.g., a delay in communication between a remote assistance system and an AV) or absence of data such as sensor data, log data, processed data, and/or any other data from the AV. The systems and technologies can dynamically and automatically enable and disable one or more actions (or suggestions or proposals) based on situational awareness in case of latency or absence of data, which can consequently improve the efficiency of remote operators' decision-making and prevent the AV from honoring any inputs which were given without the information necessary to make an informed decision by the remote operator.

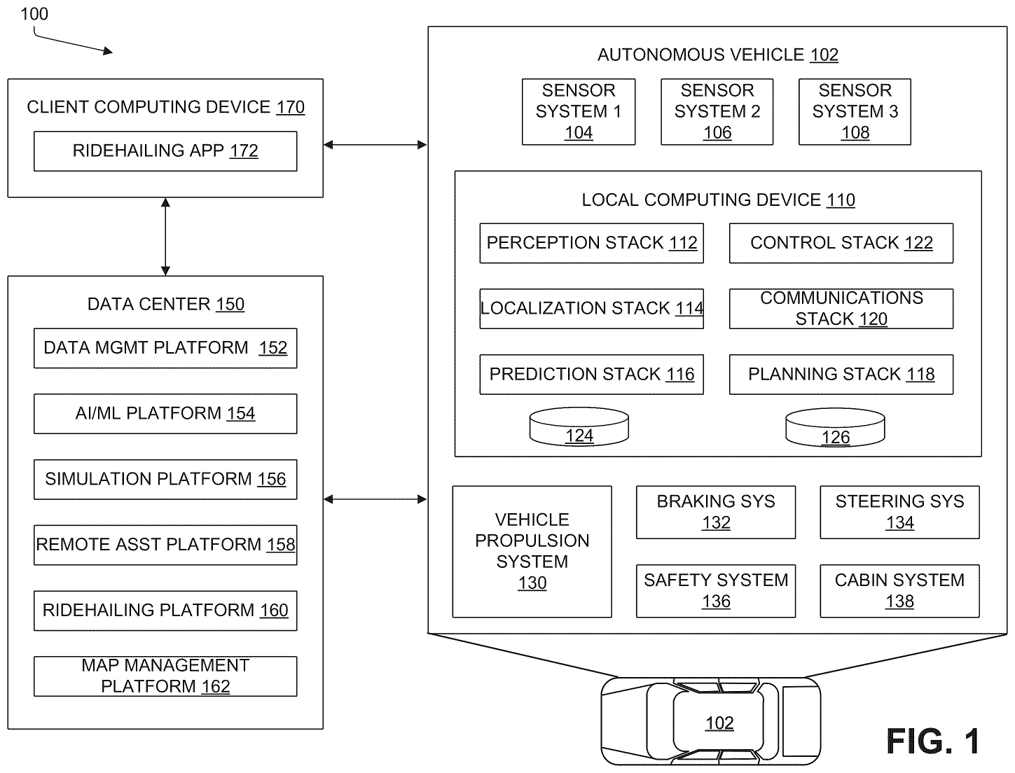

Various examples of the systems and techniques described herein for dynamically controlling a remote assistance system of an AV based on delayed or missing information/data are illustrated in FIG. 1 through FIG. 6 and described below.

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102. In some examples, the remote assistance platform 158 can facilitate adjustment of the perception of the AV 102, confirmation of the classification of an object, appropriate AV response to an emergency vehicle, etc.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 (e.g., client application) to enable passengers to view the AV 102 in transit en route to a pick-up or drop-off location, and so on.

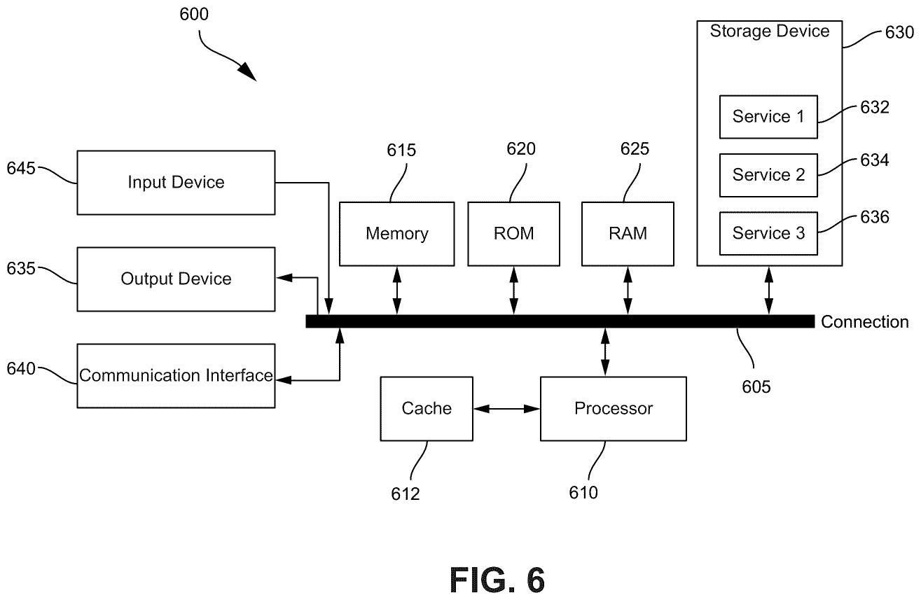

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

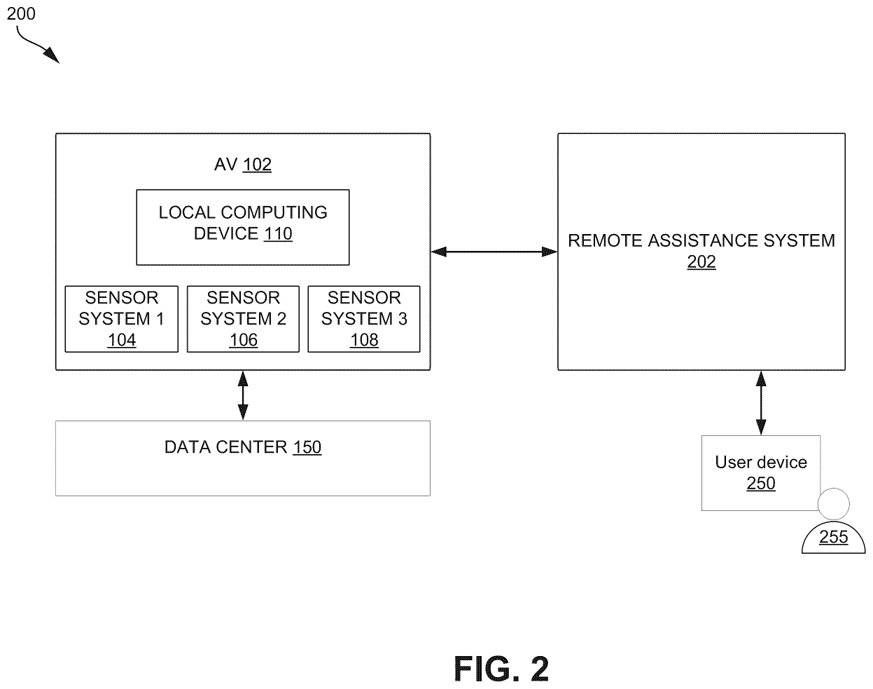

FIG. 2 illustrates an example system environment 200 in which AV 102 is in communication with a remote assistance system 202 (e.g., remote assistance platform 158 as illustrated in FIG. 1 or also referred to as a remote computing system). In some examples, remote assistance system 202 and AV 102 may establish a network connection (e.g., via Wi-Fi network, a vehicle-to-vehicle (V2V) network, a cellular network, a satellite network, or any applicable network) to facilitate data exchange and communication. While FIG. 2 depicts a single AV 102 in communication with remote assistance system 202, other examples of remote assistance system 202 may be utilized for multiple different AVs.

In the example system environment 200, remote assistance system 202 is configured to provide remote assistance to an AV (e.g., AV 102) that has encountered a scenario in which AV 102 needs remote assistance and/or is unable to handle the situation with sufficient confidence and/or without human assistance. For example, if AV 102 encounters an object that it cannot identify or AV 102 is unable to select appropriate maneuvers or plan a course of actions due to sensor failure or environmental hazards, a remote assistance request can be generated and transmitted to remote assistance system 202. Non-limiting examples of a cause that may initiate a remote assistance request may include sensor impairment (e.g., sensor failure, sensor malfunctioning, etc.); control system failure; AV operation impairment (e.g., engine problems, a flat tire, etc.); perception, prediction, and/or planning impairment (e.g., an unidentifiable object in the scene, an object blocking a view and path of the AV, etc.); vehicle rules/constraints; scene conditions; a type of scene; one or more scene features (e.g., intersection, merge lane, closed lane/road, construction zone, obstacles, etc.); and so on.

In some aspects, remote assistance can be manually requested by an occupant of AV 102 or any other party that may be associated with AV 102. Upon receiving a request for remote assistance from AV 102, remote assistance system 202 can assign a remote operator 255 to assist AV 102. In other aspects, the AV can automatically request assistance from remote assistance system 202, or remote assistance system 202 can determine that AV 102 needs assistance in a given context/situation.

In some cases, remote assistance system 202 may access (and/or receive) various data, which can provide information associated with AV 102 and the scene. For example, remote assistance system 202 can access a variety of data that is stored in AV operational database 124 and/or communicated by AV 102 such as raw AV data generated by sensor systems 104-108, stacks 112-122, and/or other components of AV 102 (e.g., HD LIDAR point cloud data, image data, RADAR data, GPS data); log data; other AV data; and/or data received by AV 102 from remote systems (e.g., data center 150 or client computing device 170) as illustrated in FIG. 1.

Non-limiting examples of data that may be accessible (and/or received) by remote assistance system 202 can include sensor data captured by one or more sensors of AV 102 (e.g., sensor system 1 104, sensor system 2 106, sensor system 3 108), historical data associated with AV 102 (e.g., maintenance history, vehicle or accident history, a historical behavior of AV 102, etc.), profile data associated with AV 102 (e.g., state of AV 102 such as occupancy status, make, model, dimensions, etc.), operation data associated with AV 102 (e.g., mode of operation running on AV 102, information about operation systems of AV 102, operating parameters, etc.), map data (e.g., geospatial information from map management platform 162, road geometry, lane geometry, locations and directions of traffic lanes, traffic zones (e.g., construction zone, school zone, etc.), road features (e.g., signage features, traffic lights, buildings, or other objects, etc.), traffic data, weather data, logged data from AV 102, scene data, planning data, AV predictions, AV detections, AV constraints, activity data, status data, etc.

As previously described, a remote assistance request can be generated for various reasons, issues, and/or scenarios. Therefore, each remote assistance request may pertain to a respective task that may depend on the reasons, issues, and/or scenarios associated with the remote assistance request. Depending on a task, different types of information and data may be needed or used to carry out or complete the task. For example, when remote assistance is requested in a scenario in which AV 102 is unable to classify a road sign, remote operator 255 can utilize image data captured by one or more sensors on AV 102, map data, or traffic data. In some cases, remote operator 255 can determine a task that is appropriate to resolve the remote assistance request. For example, remote operator 255 can choose a task from multiple options without completing any specific predetermined task.

In some examples, remote assistance system 202 can generate a remote assistance user interface (UI) that includes information relating to the data available to remote assistance system 202 about AV 102 as described above. For example, remote assistance system 202 can generate a UI to be presented at user device 250 for remote operator 255. The remote operator 255 can access information in the remote assistance UI to understand the surrounding environment of AV 102, understand the need for assistance, analyze the situation associated with a remote assistance request, determine what assistance can or should be provided to AV 102, monitor AV 102, and/or provide assistance to AV 102.

In some cases, the remote assistance UI can include one or more output elements such as a display element (e.g., a screen, a touch-sensitive screen or panel, or any suitable display, etc.). For example, the remote assistance UI can include a visual/graphical representation of the scene and AV 102 (e.g., a graphical overlay over the video or image data to display). As follows, the remote assistance UI can enable remote operator 255 to view and assess available data on user device 250.

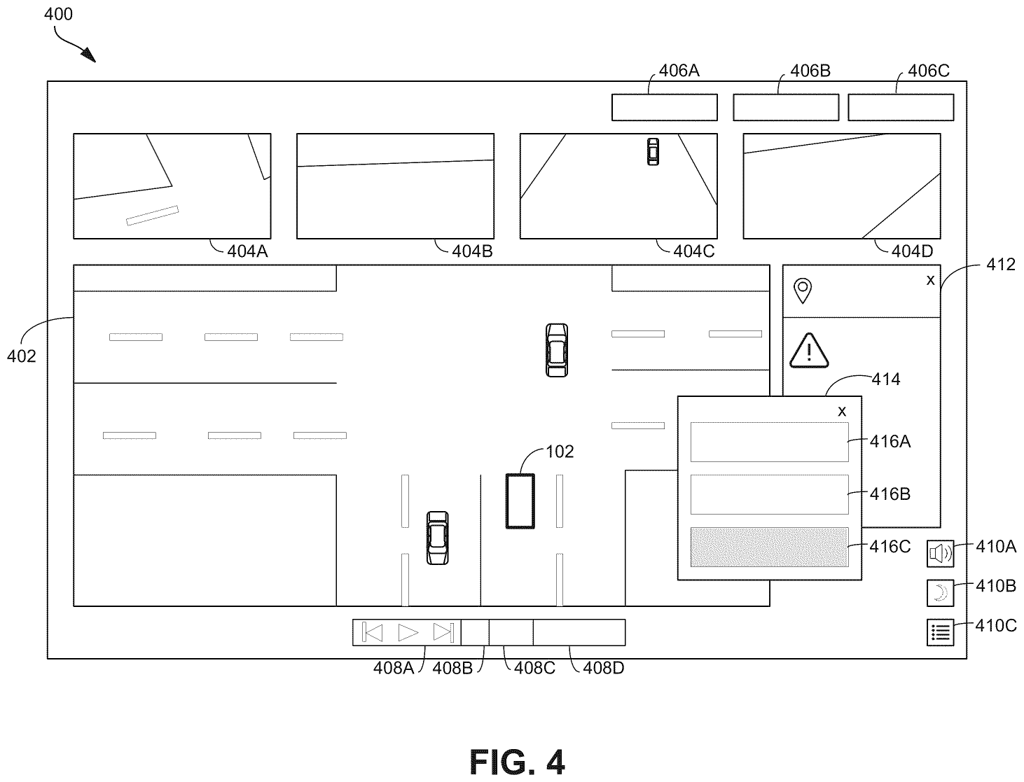

In some aspects, the remote assistance UI can include one or more input elements (e.g., a keyboard, a mouse, a tablet, a microphone, or any suitable input device). As follows, remote operator 255 can determine or select one or more remote assistance actions or instructions for a remote assistance request and provide input via an available input element of the remote assistance UI. The input from remote operator 255 can be transmitted to AV 102 for guidance. Further details of the remote assistance UI are described with respect to FIG. 4 below.

In some approaches, remote assistance system 202 may be implemented using any applicable processing system and/or device such as one or more processors or controllers similar to processor-based system 600 as described below with respect to FIG. 6.

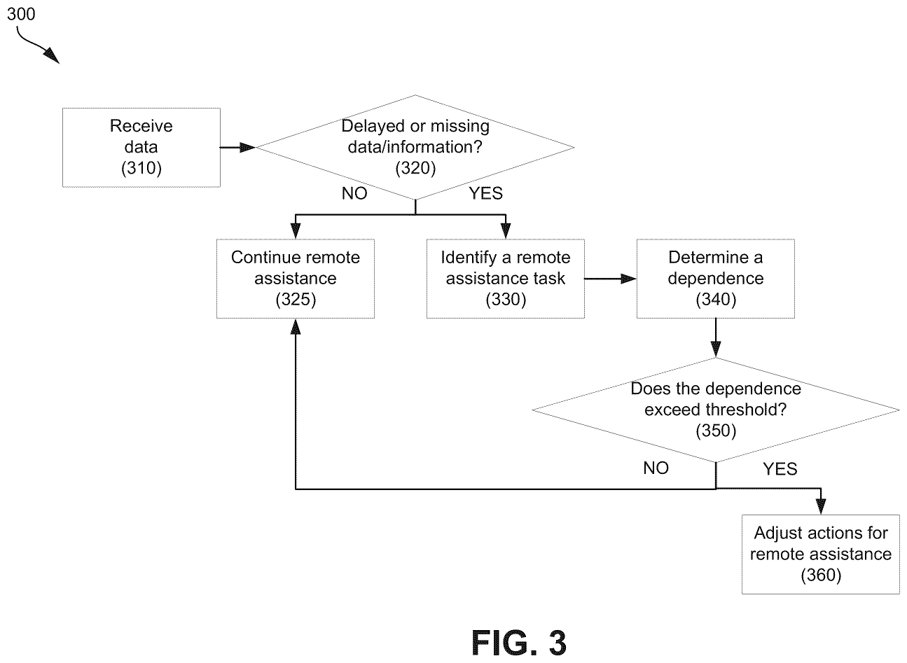

FIG. 3 is a flow diagram illustrating an example process 300 for dynamically adjusting a remote assistance system based on delayed or missing information (e.g., latency, delayed sensor data, absence of sensor data, etc.). At block 310, the process 300 can include receiving data from an AV (e.g., AV 102) at a remote assistance system (e.g., remote assistance platform 158 or remote assistance system 202). The remote assistance system can receive the data from the AV in real-time (or near real-time), at specific intervals, on-demand, and/or at any other time. The data can include raw sensor data (e.g., image data such as a video feed and/or a still image(s) of the scene and/or the AV, LIDAR data, RADAR data, time-of-flight data, sound/audio data, sensor readings and measurements, log data, perception outputs, planning data, map data, predictions, software stack outputs, state information, assistance request information, error data, event data, etc.). For example, the data can include sensor data captured by one or more sensors on AV 102 (e.g., sensor systems 104-108). Also, the sensor data may include processed sensor data (e.g., a camera view with object detection labels or classifications, three-dimensional renderings of the scene, a location of AV 102 overlaid on a map, a predicted trajectory of objects in the scene, a planned path of AV 102, etc.).

In some examples, remote assistance system (e.g., remote assistance platform 158 or remote assistance system 202) may receive data or information from a third party outside of the AV or AV system. For example, a cloud portion of the remote assistance system may receive static map data from another data source (e.g., third-party mapping data center, etc.) instead of the AV. If the map data from the third-party data source is missing or delayed, one or more actions can be prevented on a remote assistance interface while the delay or absence of the map data lasts.

At block 320, the process 300 can include determining whether there is a latency in communication between the remote assistance system and the AV or absence of data that should have been transmitted to the remote assistance system. For example, the remote assistance system can determine that there is a time delay between the data sent by AV 102 and receipt of that data by remote assistance system 202 or between an instruction sent by remote assistance system 202 and receipt of that instruction by AV 102. In some examples, the remote assistance system can determine that there is latency/delay in communicated data between the remote assistance system and the AV when there is a threshold delay in the data when received (relative to when sent). For example, the remote assistance system can determine that there is latency/delay in communicated data between the AV and the remote assistance system by comparing a timestamp indicating when the data was sent with a time when the data was received. As another example, the remote assistance system can determine that there is latency/delay in communications between the AV and the remote assistance system by exchanging messages (e.g., pings, heartbeats, etc.) between the AV and the remote assistance system to determine if there are any delays between sending such messages and receiving such messages.

In some examples, the latency in communications between the AV and the remote assistance system can be evaluated on the AV. For example, an AV can send a packet of information containing [x, y] (e.g., the knowledge that the values for x and y are not null) along with the timestamp of when the data is sent. The packet of information may reach a remote operator and a remote operator's input can be appended to the packet of data as ‘z’ and sent to the AV. The AV then receives [x, y, z] along with the timestamp of when z was added. As follows, the AV can compare the timestamp of when it sent the information with the timestamp of when the information was received. The AV can calculate the total round trip latency and make an evaluation on whether all required information was provided to a remote operator at the time the remote operator provided input. Based on such calculation and evaluation, certain input may be rejected based on the input's dependency-specific thresholds or data being present. In some cases, the calculation of the total round trip latency and the following evaluation can be performed by a remote assistance system.

In another example, the remote assistance system can determine that there is latency/delay in or absence of communicated data between the AV and the remote assistance system based on the type of assistance requested or needed by the AV and details about the AV and/or the scene determined from the data sent by the AV. For example, if the remote assistance pertains to an error or problem encountered by the AV when attempting to navigate an intersection and the data received by the AV in association with the remote assistance depicts a scene that does not include an intersection or depicts the AV a threshold distance away from an intersection, the remote assistance system may determine that the inconsistency between what the data shows and what is expected regarding the remote assistance is indicative of a latency/delay or absence of data in the AV sending that data and/or the remote assistance system receiving that data.

The time delay (or latency) can be caused by various reasons such as sensor failure or malfunctioning, data packet delay, delays in loading, delays in rendering, delays in displaying, network issues, and so on. In some examples, process 300 can further include determining which data or which sensor of AV 102 is associated with the time delay. For example, remote assistance system 202 may identify which sensor data is delayed or missing, or which sensor system of AV 102 is associated with the sensor data delay. The remote assistance system 202 may monitor a difference between what is received and what is expected, gaps in data about the scene and/or AV, lagging or unstable data packet delivery (e.g., defective pixels in image data, unresponsive or frozen display, etc.) and identify the source of delay.

If there is no delay, at block 325, the process 300 can include facilitating, by the remote assistance system, communication between the AV and a remote operator (e.g., providing and transmitting available information/data to user device 250 to be displayed for remote operator 255 to view, receiving and routing the input or instructions received from user device 250 and/or remote operator 255 to AV 102, etc.).

If there is a latency in receiving sensor data or absence of sensor data, at block 330, the process 300 can include identifying a remote assistance task for the AV. In some examples, a task can include one or more actions or a series of actions in a certain order to resolve the challenge encountered by AV 102. For example, a remote assistance task may include confirming whether a collision has occurred. If certain information is absent or delayed from a collision packet, a remote assistance system may prevent a remote operator from dismissing a collision detection as a false positive.

As previously described, a task may vary depending on the environment or scenario that triggered a remote assistance request. As follows, different types of information and/or data may be needed or used for different tasks. For example, if AV 102 is stuck in a scene (e.g., unable to drive through an area autonomously), remote assistance system 202 may need image sensor data and/or map data that can show the drivable lanes to determine an appropriate series of maneuvers to recover from the stuck condition. If AV 102 is unable to determine the direction of an emergency vehicle on the road, remote assistance system 202 may need audio data that captures the sound of a siren to determine the approximate location of the emergency vehicle or depth data to determine the distance between AV 102 and the emergency vehicle.

In some examples, at block 340, process 300 can include determining a dependence of the task on the data that is delayed. The process 300 can determine the dependence of the task on the data based on one or more parameters. For example, remote assistance system 202 can determine a level of dependence of the task on the missing or delayed sensor data (e.g., the criticality of having the delayed sensor data in resolving the remote assistance request, what the data provides, a use of such data, etc.) based on one or more parameters such as a safety parameter, a performance parameter, an environmental parameter, a timeliness parameter, or a combination thereof. In some approaches, if a series of actions (e.g., multiple sub-tasks) may be required to resolve the remote assistance request, a level of dependence of each of the sub-tasks on the missing or delayed sensor data can be determined. For example, one or more sub-tasks can be executed without fully resolving the remote assistance request and may have different dependencies on the missing or delayed sensor data.

In some cases, a safety parameter defines an estimated impact of the missing or delayed data on a safety metric of AV 102. The remote assistance system 202 can determine a safety risk or safety impact of carrying out remote assistance actions for the task associated with a remote assistance request without missing or delayed data. For example, in a scenario where AV 102 is stuck and unable to drive through the area, if image data captured by a front camera is missing or delayed (e.g., the image data captured by a front camera of AV 102 fails to be transmitted to remote assistance system 202 or the image data captured by a front camera of AV 102 is not presented on the remote assistance UI), remote assistance system 202 may determine that enabling the remote operator to provide authorization for AV 102 to “drive forward” in situations where the remote operator is responsible for determining the area shown in the missing camera feed of AV 102 is clear of objects would adversely affect the safety impact (or increase the safety risk) as the remote operator would be unable to make the necessary evaluation without the front camera view to make sure no object is located in front of AV 102. As follows, remote assistance system 202 can eliminate or deactivate the option of “authorizing forward movement” as one of the available actions presented on the remote assistance UI. For example, remote assistance system 202 can disable, hide, deactivate, or make unselectable an input element on the remote assistance UI that may be associated with an action that would adversely affect the safety impact.

In some aspects, a performance parameter defines an estimated impact of the missing or delayed data on a performance metric of AV 102. The remote assistance system 202 may determine whether one or more actions for the task associated with a remote assistance request would negatively affect the performance or operation of AV 102 (or decrease the performance level of AV 102 or comfort level of AV 102) if the data is missing or delayed. For example, in a scenario where AV 102 is unable to classify a road sign for pavement marking, missing or delayed video or image data that may be indicative of the sign can decrease the performance or comfort level of AV 102 if the remote operator provides input that does not comply with the sign.

In some examples, an environmental parameter is associated with the surrounding environment of AV 102 such as a road feature, a scene feature, a context of the AV in the scene, kinematics of object(s) in the scene, a maximum or minimum speed required in the area, and so on. For example, if the scene includes fast-moving actors (e.g., vehicles driving at high speeds around AV 102), complex lane geometries, or a construction zone, the criticality of receiving the data in real-time (or near real-time) for understanding the scene and determining one or more actions for a remote assistance request is higher compared to the scene that is within an operational design domain that may have environmental, geographical, and time-of-day restrictions or rural areas that do not have dynamic actors.

In some cases, each parameter/factor can be weighed in calculating the overall dependence of the task on the missing or delayed data so that the factors contribute differently to the overall dependence. For example, each factor can include weights or biases based on the importance of the factors in the remote operator's decision-making (e.g., determining one or more actions/suggestions for a task associated with a remote assistance request). If a safety parameter has a higher importance in the scene (e.g., due to a potential collision or safety critical event), a higher weight such as 0.9 (e.g., 90%) can be assigned to the safety parameter in determining the overall dependence. If an environmental factor has a lower importance in the scene (e.g., the scene within a rural area with no dynamic actors), a lower weight such as 0.05 (e.g., 5%) can be assigned to the environmental factor in determining the overall dependence.

In some aspects, a dependence (or a level of dependence) on the missing or delayed data can be determined via a machine learning algorithm. For example, a machine learning model can be configured to leverage available data and information (e.g., sensor data, map data, traffic data, weather data, etc.) and provide an output that is indicative of the level of dependence of the task on the missing or delayed data or the criticality of the missing or delayed data for the task associated with a remote assistance request. The machine learning model can be operable on a distributed computing system (e.g., remote assistance system 202), but may additionally or alternatively operate on any suitable computing system.

In some cases, at block 350, process 300 can include determining whether the dependence on the data exceeds a threshold. That is, if the dependence on the data is below a threshold, process 300 can proceed to block 325, and a remote assistance system can continue facilitating communication between an AV and a remote operator (e.g., providing and transmitting available information/data to user device 250 to be displayed for remote operator 255 to view, receiving and routing the input or instructions received from user device 250 and/or remote operator 255 to AV 102, etc.).

Alternatively, if the dependence on the data exceeds a threshold, process 300 can proceed to block 360, which includes adjusting one or more actions for input from a remote assistant based on the dependence of the task on the missing or delayed data. For example, dependence of the task on the missing or delayed data exceeding a threshold may indicate that the missing or delayed data is needed to perform one or more actions for the task associated with a remote assistance request.

In some aspects, a threshold for determining the dependence on the missing or delayed data can be in metrics of one or more parameters that may be associated with the latency, delay, or absence of the data. For example, if a time delay in communications of the data exceeds a predetermined time threshold (e.g., 0.1 seconds), a remote assistance system may determine that the dependence on the data exceeds a threshold and adjust display elements on a remote assistance UI (e.g., disabling one or more actions or options on the remote assistance UI, etc.).

In some examples, a remote assistance UI can be dynamically adjusted based on the dependence of the task on missing or delayed data. For example, if the dependence on the data exceeds a threshold, remote assistance system 202 may deactivate or freeze one or more actions that require the missing or delayed data. In some aspects, remote assistance system 202 may deactivate or freeze the one or more actions until missing or delayed data is received at remote assistance system 202.

FIG. 4 illustrates an example remote assistance user interface (UI) 400 for providing remote assistance to an AV (e.g., AV 102). For example, remote assistance system 202 can generate remote assistance UI 400 based on a variety of data from the AV. The data can include, for example and without limitation, sensor data (e.g., camera data, LIDAR data, RADAR data, ultrasonic data, time-of-flight data, gyroscope data, accelerometer data, steering wheel sensor data, etc.) captured by one or more sensors on AV 102, log data from AV 102, perception data from AV 102, status information from AV 102, map data, planning data, assistance request details, data from one or more software stacks (e.g., perception stack, planning stack, control stack, communications stack, etc.) of AV 102, and/or any other data from AV 102.

An example remote assistance UI 400 generated and/or provided by remote assistance system 202 may be displayed via user device 250 associated with remote operator 255. The remote operator 255 can interact with remote assistance UI 400 to analyze data presented in the remote assistance UI 400 (e.g., data from the AV) such as scene and AV data, request data via the remote assistance UI 400, communicate with the AV, provide inputs (e.g., one or more actions/suggestions/proposals) for a task associated with a remote assistance request, control the AV, etc.

As illustrated, remote assistance UI 400 can include a graphical/visual representation of the scene and AV 102. The remote assistance UI 400 can include a map display window 402, which includes a visual representation of the position and location of AV 102 in the scene and visual representations of road features and scene features (e.g., moving objects such as pedestrians, vehicles, bicycles, etc., static objects such as trees, buildings, etc., lane lines, road signs, traffic lights, and so on) overlaid on a map. In some examples, map display window 402 can include a planned path of AV 102 and predicted trajectories of object(s) in the scene overlaid on the map.

The remote assistance UI 400 can include sub-windows 404A-D for a graphical/visual representation of the scene or the surrounding environment in different views (e.g., bird-eye view, eye level view, AV's point of view, three-dimensional view, etc.). In some examples, sub-windows 404A-D can include a video stream or still image of a portion of the scene or the surrounding environment and provide various views of the environment (e.g., video or still image captured by a front camera on AV 102, video or still image captured by a rear camera on AV 102, three dimensional (3D) image of the scene generated by a 3D rendering of image data, etc.). Accordingly, remote operator 255 can understand the position and behavior of AV 102 with respect to other features and agents in the scene based on views of the surrounding environment provided in any of the sub-windows 404A-D.

In some cases, remote assistance UI 400 can include interface elements 406A-C, 408A-D, and 410A-C that allow remote operator 255 to provide inputs for interacting with the remote assistance UI 400 and the AV. The interface elements 406A-C, 408A-D, and 410A-C can include, for example and without limitation, a playback bar, slider or a seek bar, time scale, a mute button, a volume control, a play speed, a control menu, a mode, zoom in/out, edit tools, AV control and/or interaction tools, and so on. For example, the remote operator 255 may play forward and reverse, pause, stop, to view the scene in different views at different points in time, which allows remote operator 255 to have a temporal understanding of the scene and/or a behavior of AV 102 (e.g., not only what is currently perceived by sensors on AV 102 but also what has been recently perceived).

In some aspects, remote assistance UI 400 may include a remote assistance toolbox 412, which presents a remote assistance request and detailed information about the scene/situation that initiated the remote assistance request. In some cases, remote assistance toolbox 412 can include a timestamp indicative of when the remote assistance request is received so that remote operator 255 can have a temporal understanding of the situation.

In some cases, remote assistance UI 400 may include a control menu 414, which includes one or more potential actions 416A-C (or a series of actions in a certain order) that remote operator 255 can select for remote assistance. For example, control menu 414 can present a course of available/potential actions 416A-C that can be selected by remote operator 255 (e.g., via clicking, pressing, etc.) to resolve the issue indicated in a remote assistance request. Consequently, the selected action can be transmitted to AV 102. In some examples, when an action is selected via the control menu 414, remote assistance system 202 can send a command or instruction to AV 102 to implement that action. For example, remote assistance system 202 can send a command to a software of AV 102 to trigger an operation of AV 102. As another example, remote assistance system 202 can send planning/routing/navigation instructions to AV 102 to assist AV 102.

In some examples, control menu 414 can be dynamically controlled and customized. For example, in case of latency in communication between remote assistance system 202 and AV 102 (e.g., a time delay in data transmission from AV 102 to remote assistance system 202) or absence of data or missing information, any potential actions 416A-C that may be presented to remote operator 255 can be dynamically adjusted based on determining the dependence of the potential actions 416A-C on the missing or delayed data as illustrated with respect to FIG. 3. For example, if carrying out action 416C would impair the safety, performance, or operation of AV 102 without taking into account the missing or delayed data, the input element for action 416C can be deactivated, frozen, removed, or unselectable so that remote operator 255 cannot select or trigger action 416C.

Those skilled in the art will understand that map display window 402, sub-windows 404A-D, interface elements 406A-C, 408A-D, and 410A-C, remote assistance toolbox 412, and control menu 414 can be in any applicable number of boxes/buttons without departing the scope of the disclosed technology.

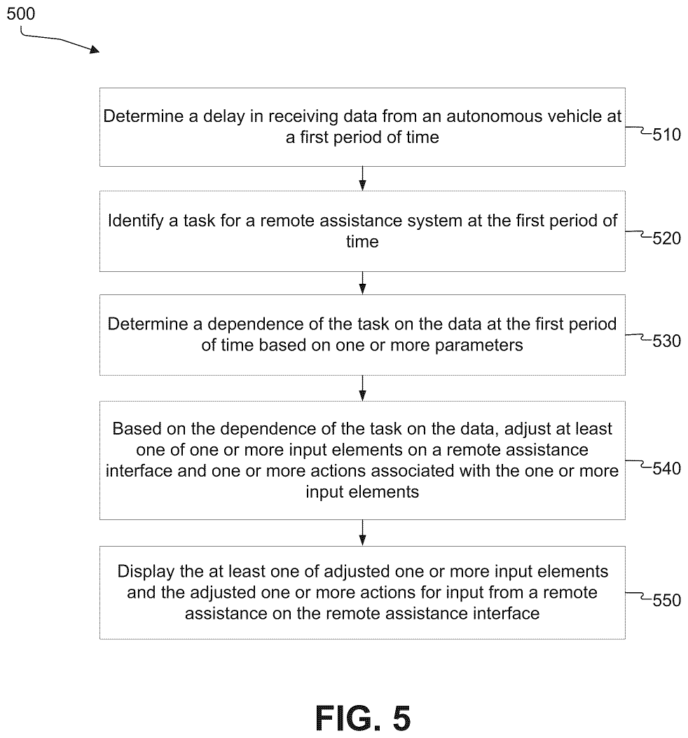

FIG. 5 is a flowchart illustrating an example process 500 for dynamically controlling a remote assistance system of an AV based on data latency. Although the example process 500 depicts a particular sequence of operations, the sequence may be altered without departing from the scope of the present disclosure. For example, some of the operations depicted may be performed in parallel or in a different sequence that does not materially affect the function of process 500. In other examples, different components of an example device or system that implements process 500 may perform functions at substantially the same time or in a specific sequence.

At block 510, process 500 includes determining a delay in receiving data from an autonomous vehicle at a first period of time. The data can relate to a remote assistance event experienced by the AV and/or a remote assistance request from the AV. In some cases, a portion of the data can include sensor data captured by a sensor(s) on the autonomous vehicle while navigating in a scene. In some examples, the data can include sensor data, log data, a remote assistance request, details associated with the remote assistance request, state information, perception data, map data, planning data, data from one or more software stacks of the autonomous vehicle, etc.

The delay can be determined based on one or more factors such as, for example, a time (e.g., a timestamp) when the data was sent relative to a time when the data was received, a content of the data, a relevance of the content of the data to information associated with an assistance request from the autonomous vehicle, etc. For example, the remote assistance system 202 can determine that certain data was not received at a first timestamp. As another example, the remote assistance system 202 can determine that certain data received from AV 102 is incomplete or missing expected data. The remote assistance system 202 can determine that there is latency (e.g., a time delay) in communication between remote assistance system 202 and AV 102 or absence of data that should have been delivered. In some cases, remote assistance system 202 can identify which sensor data is missing or delayed, or which sensor system of AV 102 is associated with the missing or delayed data.

At block 520, process 500 includes identifying a task for a remote assistance system after receiving the data (and/or an associated remote assistance request). The task includes one or more actions that can be triggered via one or more input elements on a remote assistance UI. For example, remote assistance system 202 can identify a task that needs to be resolved in response to a remote assistance request. The task can include one or more actions or a series of actions (e.g., one or more potential actions 416A-C as illustrated in FIG. 4) that can be selected by remote operator 255 via one or more input elements on the remote assistance UI 400.

At block 530, process 500 includes determining a dependence of the task on the data based on one or more parameters. For example, remote assistance system 202 can determine the dependence of the task on the missing or delayed data based on one or more parameters such as, for example, a safety parameter, a performance parameter, an environmental parameter, a timeliness parameter, and so on.

In some examples, the dependence of the task on the data can be determined based on a safety parameter that defines an estimated impact of the data on a safety metric of the AV. For example, remote assistance system 202 can determine whether each of the one or more potential actions 416A-C can be carried out within a safety threshold/metric without taking into account the missing or delayed data. If the safety risk of performing action 416C exceeds a safety threshold, remote assistance system 202 may deactivate or eliminate action 416C so that remote operator 255 cannot select action 416C in response to a remote assistance request.

In some aspects, the dependence of the task on the data can be determined based on a performance parameter that defines an estimated impact of the data on a performance metric of the AV. For example, remote assistance system 202 can determine whether each of the one or more potential actions 416A-C can be carried out without impacting (or with less than a threshold impact) the performance or operation of AV 102 when the data is missing or delayed.

In some cases, the dependence of the task on the data can be determined based on an environmental parameter such as a road feature, a scene feature, a context of the AV in the scene, kinematics of one or more objects in the scene, and so on. For example, remote assistance system 202 can determine whether any of the factors associated with the environmental parameter would increase or decrease the latency threshold. In other words, if the scene includes actors moving above a threshold speed, complex lane geometries, or a construction zone, the criticality of receiving data in real-time (or near real-time) for understanding the scene and determining one or more actions for a remote assistance request is higher compared to the scene that is within a tightly controlled operational design domain that may have environmental, geographical, and time-of-day restrictions, or rural areas that do not have actors moving above a threshold speed. As follows, depending on the environmental parameters associated with the scene, remote assistance system 202 may determine that the missing or delayed data needs to be considered for performing one or more potential actions 416A-C.

In some approaches, the dependence of the task on the data can be determined based on a timeliness parameter that represents a criticality of the data. For example, remote assistance system 202 can determine whether each of the one or more potential actions 416A-C can be carried out without the missing or delayed data at a later time when the data is received. For example, if remote operator 255 would not be utilizing or need the missing or delayed data after it is received at a later time for determining one or more actions for a remote assistance request, the missing or delayed data may not have any impact on the remote operator's decision-making and therefore, no adjustment needs to be made to the available one or more actions or suggestions for a task associated with the remote assistance request. Also, remote operator 255 may continue to make progress with task(s) while simultaneously waiting for the latency/delay to decrease so that subsequent actions for the task(s) can be unlocked.

At block 540, process 500 includes adjusting the one or more actions and/or one or more input elements on the remote assistance UI that are associated with the one or more actions based on the dependence of the task on the data. For example, remote assistance system 202 can disable at least one action 416C (and/or a corresponding input element) of the one or more potential actions 416A-C on remote assistance UI 400 to prevent the remote operator 255 from triggering that action (and/or selecting/activating the corresponding input element). In some examples, the process 500 can adjust the one or more actions and/or the one or more associated input elements until a second period of time. The second period of time can include a time when the delayed data is received, a time when updated data is received from the AV, a fixed or predetermined time interval, a time when a circumstance and/or context of the AV changes, and/or any other time.

At block 550, process 500 includes providing the remote assistance UI with the adjusted one or more actions and/or associated one or more input elements to a device associated with a remote assistant. In some examples, providing the remote assistance UI can include updating the remote assistance UI and/or a rendering (e.g., on the device associated with the remote assistant) of the remote assistance UI to reflect the adjustment of the one or more actions and/or the one or more input elements. This way, the process 500 can dynamically adjust what inputs the remote assistant can provide to the AV from the remote assistance UI to account for delays in data from the autonomous vehicle.

In some aspects, providing the remote assistance UI can include displaying the remote assistance UI. For example, remote assistance system 202 can display the remote assistance UI reflecting the adjustment of the one or more actions and/or the one or more input elements associated with the one or more actions. In some cases, the adjusted one or more actions may have action 416C removed, deactivated or unselectable so that remote operator 255 cannot choose in response to a remote assistance request.

FIG. 6 illustrates an example processor-based system with which some aspects of the subject technology can be implemented. For example, processor-based system 600 can be any computing device making up local computing device 110, client computing device 170, a passenger device executing the ride-hailing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some examples, a hardware service that performs a particular function can include the software component stored in a computer-readable medium in connection with the necessary hardware components, such as processor 610, connection 605, output device 635, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A remote assistance system comprising: a memory; and one or more processors coupled to the memory, the one or more processors being configured to: determine a delay in receiving data from an autonomous vehicle at a first period of time, wherein at least a portion of the data is captured by a sensor on the autonomous vehicle while navigating in a scene; identify a task for the remote assistance system at the first period of time, wherein the task includes one or more actions corresponding to one or more input elements on a remote assistance interface; determine a dependence of the task on the data at the first period of time, the dependence being determined based on one or more parameters; and based on the dependence of the task on the data, adjust at least one of the one or more input elements of the remote assistance interface and the one or more actions associated with the one or more input elements.

Aspect 2. The remote assistance system of Aspect 1, wherein the one or more processors are configured to: display the at least one of adjusted one or more input elements and the adjusted one or more actions for input from a remote assistant on the remote assistance interface.

Aspect 3. The remote assistance system of Aspects 1 or 2, wherein adjusting the one or more actions includes disabling an input element corresponding to at least one action of the one or more actions.

Aspect 4. The remote assistance system of any of Aspects 1 to 3, wherein the one or more parameters include a safety parameter that defines an estimated impact of the data on a safety metric of the autonomous vehicle.

Aspect 5. The remote assistance system of any of Aspects 1 to 4, wherein the one or more parameters include a performance parameter that defines an estimated impact of the data on a performance metric of the autonomous vehicle.

Aspect 6. The remote assistance system of any of Aspects 1 to 5, wherein the one or more parameters include an environmental parameter comprising at least one of a road feature, a scene feature, a context of the autonomous vehicle in the scene, and kinematics of one or more objects in the scene.

Aspect 7. The remote assistance system of any of Aspects 1 to 6, wherein the one or more parameters include a timeliness parameter that represents a criticality of the data at the time the data should have been received.

Aspect 8. A method comprising: determining a delay in receiving data from an autonomous vehicle at a first period of time, wherein at least a portion of the data is captured by a sensor on the autonomous vehicle while navigating in a scene; identifying a task for a remote assistance system at the first period of time, wherein the task includes one or more actions corresponding to one or more input elements on a remote assistance interface; determining a dependence of the task on the data at the first period of time, the dependence being determined based on one or more parameters; and based on the dependence of the task on the data, adjusting at least one of the one or more input elements of the remote assistance interface and the one or more actions associated with the one or more input elements.

Aspect 9. The method of Aspect 8, further comprising: displaying the at least one of adjusted one or more input elements and the adjusted one or more actions for input from a remote assistant on the remote assistance interface.

Aspect 10. The method of Aspects 8 or 9, wherein adjusting the one or more actions includes disabling an input element corresponding to at least one action of the one or more actions.

Aspect 11. The method of any of Aspects 8 to 10, wherein the one or more parameters include a safety parameter that defines an estimated impact of the data on a safety metric of the autonomous vehicle.

Aspect 12. The method of any of Aspects 8 to 11, wherein the one or more parameters include a performance parameter that defines an estimated impact of the data on a performance metric of the autonomous vehicle.

Aspect 13. The method of any of Aspects 8 to 12, wherein the one or more parameters include an environmental parameter comprising at least one of a road feature, a scene feature, a context of the autonomous vehicle in the scene, and kinematics of one or more objects in the scene.

Aspect 14. The method of any of Aspects 8 to 13, wherein the one or more parameters include a timeliness parameter that represents a criticality of the data at the time the data should have been received.

Aspect 15. A non-transitory computer-readable medium having stored thereon instructions which, when executed by one or more processors, cause the one or more processors to perform a method according to any of Aspects 8 to 14.

Aspect 16. An autonomous vehicle comprising a computer device having stored thereon instructions which, when executed by the computing device, cause the computing device to perform a method according to any of Aspects 8 to 14.

Aspect 17. A computer-program product comprising instructions which, when executed by one or more processors, cause the one or more processors to perform a method according to any of Aspects 8 to 14.

What is claimed is:

1. A remote assistance system comprising:
a memory; and
one or more processors coupled to the memory, the one or more processors being configured to:
determine a delay in receiving data from an autonomous vehicle at a first period of time, wherein at least a portion of the data is captured by a sensor on the autonomous vehicle while navigating in a scene;
identify a task for the remote assistance system at the first period of time, wherein the task includes one or more actions corresponding to one or more input elements on a remote assistance interface;
determine a dependence of the task on the data at the first period of time, the dependence being determined based on one or more parameters; and
based on the dependence of the task on the data, adjust at least one of the one or more input elements of the remote assistance interface and the one or more actions associated with the one or more input elements.

2. The remote assistance system of claim 1, wherein the one or more processors are configured to:
display the at least one of adjusted one or more input elements and the adjusted one or more actions for input from a remote assistant on the remote assistance interface.

3. The remote assistance system of claim 1, wherein adjusting the one or more actions includes disabling an input element corresponding to at least one action of the one or more actions.

4. The remote assistance system of claim 1, wherein the one or more parameters include a safety parameter that defines an estimated impact of the data on a safety metric of the autonomous vehicle.

5. The remote assistance system of claim 1, wherein the one or more parameters include a performance parameter that defines an estimated impact of the data on a performance metric of the autonomous vehicle.

6. The remote assistance system of claim 1, wherein the one or more parameters include an environmental parameter comprising at least one of a road feature, a scene feature, a context of the autonomous vehicle in the scene, and kinematics of one or more objects in the scene.

7. The remote assistance system of claim 1, wherein the one or more parameters include a timeliness parameter that represents a criticality of the data at the time the data should have been received.

8. A method comprising:
determining a delay in receiving data from an autonomous vehicle at a first period of time, wherein at least a portion of the data is captured by a sensor on the autonomous vehicle while navigating in a scene;
identifying a task for a remote assistance system at the first period of time, wherein the task includes one or more actions corresponding to one or more input elements on a remote assistance interface;
determining a dependence of the task on the data at the first period of time, the dependence being determined based on one or more parameters; and
based on the dependence of the task on the data, adjusting at least one of the one or more input elements of the remote assistance interface and the one or more actions associated with the one or more input elements.

9. The method of claim 8, further comprising:
displaying the at least one of adjusted one or more input elements and the adjusted one or more actions for input from a remote assistant on the remote assistance interface.

10. The method of claim 8, wherein adjusting the one or more actions includes disabling an input element corresponding to at least one action of the one or more actions.

11. The method of claim 8, wherein the one or more parameters include a safety parameter that defines an estimated impact of the data on a safety metric of the autonomous vehicle.

12. The method of claim 8, wherein the one or more parameters include a performance parameter that defines an estimated impact of the data on a performance metric of the autonomous vehicle.

13. The method of claim 8, wherein the one or more parameters include an environmental parameter comprising at least one of a road feature, a scene feature, a context of the autonomous vehicle in the scene, and kinematics of one or more objects in the scene.

14. The method of claim 8, wherein the one or more parameters include a timeliness parameter that represents a criticality of the data at the time the data should have been received.

15. A non-transitory computer-readable medium having stored thereon instructions which, when executed by one or more processors, cause the one or more processors to:
determine a delay in receiving data from an autonomous vehicle at a first period of time, wherein at least a portion of the data is captured by a sensor on the autonomous vehicle while navigating in a scene;
identify a task for a remote assistance system at the first period of time, wherein the task includes one or more actions corresponding to one or more input elements on a remote assistance interface;
determine a dependence of the task on the data at the first period of time, the dependence being determined based on one or more parameters; and
based on the dependence of the task on the data, adjust at least one of the one or more input elements of the remote assistance interface and the one or more actions associated with the one or more input elements.

16. The non-transitory computer-readable medium of claim 15, wherein the instructions cause the one or more processors to:
display the at least one of adjusted one or more input elements and the adjusted one or more actions for input from a remote assistant on the remote assistance interface.

17. The non-transitory computer-readable medium of claim 15, wherein adjusting the one or more actions includes disabling an input element corresponding to at least one action of the one or more actions.

18. The non-transitory computer-readable medium of claim 15, wherein the one or more parameters include a safety parameter that defines an estimated impact of the data on a safety metric of the autonomous vehicle.

19. The non-transitory computer-readable medium of claim 15, wherein the one or more parameters include a performance parameter that defines an estimated impact of the data on a performance metric of the autonomous vehicle.

20. The non-transitory computer-readable medium of claim 15, wherein the one or more parameters include an environmental parameter comprising at least one of a road feature, a scene feature, a context of the autonomous vehicle in the scene, and kinematics of one or more objects in the scene.
